(19) United States
(12) Patent Application Publication
(10) Pub. No.: US 2019/0009510 A1
(43) Pub. Date: Jan. 10, 2019

(54) PLASTIC FILM AND PLASTIC FILM HAVING THE PLASTIC FILM LAYER

(71) Applicant: Dongguan Sengtor Plastic Products Co., Ltd., Dongguan (CN)

(72) Inventor: Xuefen Ren, Dongguan (CN)

(21) Appl. No.: 15/798,431

(22) Filed: Oct. 31, 2017

Related U.S. Application Data
(63) Continuation of application No. PCT/CN2017/092383, filed on Jul. 10, 2017.

(51) Int. Cl. B32B 27/32; B32B 27/08; B32B 27/20; C08J 5/18

(52) U.S. Cl. CPC B32B 27/327; B32B 27/08; B32B 27/20; C08J 5/18; C08J 2477/06; C08J 2323/12; C08J 2423/12; C08J 2423/02; B32B 2323/10

(57) ABSTRACT

A plastic film layer includes polyolefin elastomers. The polyolefin elastomers have better fluidity and can improve the dispersion effect of polypropylene base raw materials. The polypropylene base raw materials are mixed evenly, and enhance the bonding strength between plastic film layers. The plastic film layer also includes a polyaniline resin. A plastic film having the plastic film layer is also provided. The plastic film layer and the plastic film applying the plastic film layer have strong tensile force and are not easily damaged.

### CROSS REFERENCE TO RELATED APPLICATIONS

The present application is a Continuation Application of PCT Application No. PCT/CN2017/092383 filed on Jul. 10, 2017. All the above are hereby incorporated by reference.

### FIELD

The subject matter herein generally relates to plastic films.

### BACKGROUND

A plastic film is a film made of polyvinyl chloride, polyethylene, polystyrene and other resins. The plastic film is used for packaging and as a coating.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a plastic film layer and a plastic film having the plastic film layer.

One exemplary embodiment of a plastic film layer is illustrated as follows.

The plastic film layer comprises a polypropylene base raw material, a polyolefin elastomer, and a polyphthalamide resin. In at least one exemplary embodiment, a weight percentage range of the polypropylene base material is substantially 86-98 percent, a weight percentage range of the polyolefin elastomer is substantially 2-14 percent, and a weight percentage range of the polyphthalamide resin is substantially 0.1-1.0 percent.

The polypropylene base raw material comprises a first polypropylene raw material and a second polypropylene raw material. The first and second polypropylene raw materials can complement each other. In at least one exemplary embodiment, a weight of the second polypropylene raw material is substantially 1-4 times that of the first polypropylene raw material. Preferably, in each raw material of the plastic film layer, the weight of the first polypropylene material is 23 kilogramms (kg), the weight of the second polypropylene material is 69 kg, the weight of the second polypropylene material is three times that of the first polypropylene material, and the weight percentage of the polypropylene base material is substantially 92 percent, which ensures the strength of the plastic film layer. Specifically, the first polypropylene raw material is an injection molding grade homopolymer polypropylene, and the second polypropylene raw material is a blown film grade homopolymer polypropylene. The first polypropylene raw material has the highest strength but poor resistance. The second polypropylene raw material can make up for this defect of poor resistance and make the strength of the base materials of the plastic film layer better.

Preferably, in each raw material of the plastic film layer, a weigh of the polyolefin elastomer is 7.5 kg and a weight percentage of the polyolefin elastomer is substantially 7.5 percent. Specifically, the polyolefin elastomer is a metallocene polyolefin elastomer, which has better fluidity, can improve the dispersion effect of polypropylene based raw materials, and can improve the bonding strength between plastic film layers.

Preferably, in each raw material of the plastic film layer, a weigh of the polyphthalamide resin is 0.5 kg, and a weight percentage of the polyphthalamide resin is substantially 0.5 percent. Specifically, the polyphthalamide resin is a semi-crystalline polyophthalamide resin. The semi-crystalline polyophthalamide resin can make the components more compact and enhance the tensile force effectively.

Preferably, the plastic film layer also comprises a pigment. In each raw material of the plastic film layer, a weight of the pigment is determined as needed, a fixed weight proportion of the pigment is not required, and the pigment is used to color the plastic film layer and colors the plastic film layer reasonably.

A plastic film is illustrated. In at least one exemplary embodiment, the plastic film comprises at least two plastic film layers. The at least two plastic film layers are extruded as a plastic film between each plastic film layer. In a first exemplary embodiment, a plastic film comprising two plastic film layers is illustrated as follows.

Preferably, the two plastic film layers are extruded as a plastic film between the two plastic film layers.

Each plastic film layer comprises a polypropylene base raw material, a polyolefin elastomer, and a polyphthalamide resin. In at least one exemplary embodiment, a weight percentage range of the polypropylene base material is substantially 86-98 percent, a weight percentage range of the polyolefin elastomer is substantially 2-14 percent, and a weight percentage range of the polyphthalamide resin is substantially 0.1-1.0 percent.

The polypropylene base raw material comprises a first polypropylene raw material and a second polypropylene raw material. The first and second polypropylene raw materials can complement each other. In at least one exemplary embodiment, a weight of the second polypropylene raw material is substantially 1-4 times that of the first polypropylene raw material. Preferably, in each raw material of the plastic film layer, a weight of the first polypropylene material is 23 kg, a weight of the second polypropylene material is 69 kg, the weight of the second polypropylene material is three times that of the first polypropylene material, and the weight percentage of the polypropylene base material is substantially 92 percent, which ensures the strength of the plastic film layer. Specifically, the first polypropylene raw material is an injection molding grade homopolymer polypropylene, and the second polypropylene raw material is a blown film grade homopolymer polypropylene. The first polypropylene raw material has the highest strength but poor resistance. The second polypropylene raw material can make up for this defect of poor resistance and make the strength of the base materials of the plastic film layer better.

Preferably, in each raw material of the plastic film layer, a weigh of the polyolefin elastomer is 7.5 kg, and a weight percentage of the polyolefin elastomer is substantially 7.5 percent. Specifically, the polyolefin elastomer is metallocene polyolefin elastomer, which has better fluidity, can improve the dispersion effect of polypropylene based raw materials, and can improve the bonding strength between plastic film layers.

Preferably, in each raw material of the plastic film layer, a weigh of the polyphthalamide resin is 0.5 kg, and a weight percentage of the polyphthalamide resin is substantially 0.5 percent. Specifically, the polyphthalamide resin is a semi-crystalline polyophthalamide resin. The semi-crystalline polyophthalamide resin can make the components more compact and effectively enhance the tensile force.

Preferably, each plastic film layer also comprises a pigment. Specifically, in the raw material of one plastic film layer, the pigment is white and weighs 10.6 grams (g), and colors white for the plastic film layer; in the raw material of the other plastic film layer, the pigment is grey, weighs 9.7 g, and colors grey for the other plastic film layer.

In a second exemplary embodiment, a plastic film comprising three plastic film layers is illustrated as follows.

Preferably, the three plastic film layers are extruded as a plastic film between the three plastic film layers. The three plastic film layers are named a first plastic film layer, a second plastic film layer, and a third plastic film layer.

Each plastic film layer comprises a polypropylene base raw material, a polyolefin elastomer, and a polyphthalamide resin. In at least one exemplary embodiment, a weight percentage range of the polypropylene base material is substantially 86-98 percent, a weight percentage range of the polyolefin elastomer is substantially 2-14 percent, and a weight percentage range of the polyphthalamide resin is substantially 0.1-1.0 percent.

The polypropylene base raw material comprises a first polypropylene raw material and a second polypropylene raw material. The first and second polypropylene raw materials can complement each other. In at least one exemplary embodiment, a weight of the second polypropylene raw material is substantially 1-4 times that of the first polypropylene raw material. Preferably, in each raw material of the plastic film layer, a weight of the first polypropylene material is 23 kg, a weight of the second polypropylene material is 69 kg, the weight of the second polypropylene material is three times that of the first polypropylene material, and the weight percentage of the polypropylene base material is substantially 92 percent, which ensures the strength of the plastic film layer. Specifically, the first polypropylene raw material is an injection molding grade homopolymer polypropylene, and the second polypropylene raw material is a blown film grade homopolymer polypropylene. The first polypropylene raw material has the highest strength but poor resistance. The second polypropylene raw material can make up for this defect of poor resistance and make the strength of the base materials of the plastic film layer better.

Preferably, in each raw material of the plastic film layer, a weigh of the polyolefin elastomer is 7.5 kg, and a weight percentage of the polyolefin elastomer is substantially 7.5 percent. Specifically, the polyolefin elastomer is metallocene polyolefin elastomer, which has better fluidity, can improve the dispersion effect of polypropylene based raw materials, and can improve the bonding strength between plastic film layers.

Preferably, in each raw material of the plastic film layer, a weigh of the polyphthalamide resin is 0.5 kg, and a weight percentage of the polyphthalamide resin is substantially 0.5 percent. Specifically, the polyphthalamide resin is a semi-crystalline polyophthalamide resin. The semi-crystalline polyophthalamide resin can make the components more compact and effectively enhance the tensile force.

Preferably, each plastic film layer also comprises a pigment. Specifically, in each raw material of the first and second plastic film layers, the pigment is white, weighs 10.6 g, and colors white for the first and second plastic film layers; in the raw material of the third plastic film layer, the pigment is grey, weighs 9.7 g, and colors grey for the third plastic film layer.

The exemplary embodiments shown and described above are only examples. Many details are often found in the art such as the other features of a plastic film layer and a plastic film having the plastic film layer. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A plastic film layer comprising:
a polypropylene base raw material;
a polyolefin elastomer; and
a polyphthalamide resin.

2. The plastic film layer of claim 1, wherein a weight percentage range of the polypropylene base material is substantially 86-98 percent, a weight percentage range of the polyolefin elastomer is substantially 2-14 percent, and a weight percentage range of the polyphthalamide resin is substantially 0.1-1.0 percent.

3. The plastic film layer of claim 2, wherein a weight percentage of the polypropylene base material is substantially 92 percent, a weight percentage of the polyolefin elastomer is substantially 7.5 percent, and a weight percentage of the polyphthalamide resin is substantially 0.5 percent.

4. The plastic film layer of claim 2, wherein the polypropylene base raw material comprises a first polypropylene raw material and a second polypropylene raw material.

5. The plastic film layer of claim 4, wherein the first polypropylene raw material is an injection molding grade homopolymer polypropylene, and the second polypropylene raw material is a blown film grade homopolymer polypropylene.

6. The plastic film layer of claim 4, wherein a weight of the second polypropylene material is substantially 1-4 times that of the first polypropylene material.

7. The plastic film layer of claim 6, wherein the weight of the second polypropylene material is three times that of the first polypropylene material.

8. The plastic film layer of claim 2, wherein the polyolefin elastomer is a metallocene polyolefin elastomer.

9. The plastic film layer of claim 2, wherein the polyphthalamide resin is a semi-crystalline polyophthalamide resin.

10. The plastic film layer of claim 2, wherein the plastic film layer also comprises a pigment.

11. A plastic film, comprising at least two plastic film layers of claim 1.

12. The plastic film of claim 11, wherein a weight percentage range of the polypropylene base material is substantially 86-98 percent, a weight percentage range of the polyolefin elastomer is substantially 2-14 percent, and a weight percentage range of the polyphthalamide resin is substantially 0.1-1.0 percent.

13. The plastic film of claim 12, wherein a weight percentage of the polypropylene base material is substantially 92 percent, a weight percentage of the polyolefin elastomer is substantially 7.5 percent, and a weight percentage of the polyphthalamide resin is substantially 0.5 percent.

14. The plastic film of claim 11, wherein the at least two plastic film layers are extruded as a plastic film between each plastic film layer.

15. The plastic film of claim 11, comprising two plastic film layers, wherein each plastic film layer comprises a pigment.

16. The plastic film of claim 15, wherein in the raw material of one plastic film layer, the pigment is white; and in the raw material of the other plastic film layer, the pigment is grey.

17. The plastic film of claim 15, wherein in the raw material of one plastic film layer, the pigment weighs 10.6 grams (g); and in the raw material of the other plastic film layer, the pigment weighs 9.7 g.

18. The plastic film of claim 14, comprising three plastic film layers named a first plastic film layer, a second plastic film layer, and a third plastic film layer, wherein each plastic film layer comprises a pigment.

19. The plastic film of claim 18, wherein in each raw material of the first and second plastic film layers, the pigment is white, and in the raw material of the third plastic film layer, the pigment is grey.

20. The plastic film of claim 18, wherein in each raw material of the first and second plastic film layers, the pigment weighs 10.6 g, and in the raw material of the third plastic film layer, the pigment weighs 9.7 g.
